(19) United States
(12) Patent Application Publication
(10) Pub. No.: US 2003/0171131 A1
(43) Pub. Date: Sep. 11, 2003

(54) Mobile radiotelephone antenna array with adjustable directional characteristic

(76) Inventors: Karl-Georg Kettering, Bern (CH); Markus Doetsch, Schliern bei Koniz (CH)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/345,488

(22) Filed: Jan. 17, 2003

(30) Foreign Application Priority Data
Jan. 23, 2002 (EP) EP02 001 533.5

(51) Int. Cl. H04B 7/00

(52) U.S. Cl. 455/522; 455/25

(57) ABSTRACT

The present invention comprises a device for the reception and transmission of electromagnetic waves, the device being well suited for very complex radiation diagrams while remaining within predefined transmission power levels. This is effected by an antenna structure and a driver logic circuit which are provided for the transmitting elements in such a way that an individually presettable directional and/or angular limitation of the basic transmitting power to maximally permitted transmitting powers in selectable directions and in particular in selectable solid angles is provided. Accordingly, the radiated transmitting power for determined directions and/or determined solid angles deviates downwards from the normal in the remaining directions and/or solid angles radiated basic transmitting power. The antenna is thereby easily calculable in so far as determined directions and/or solid angles are assigned to certain antenna pieces and preset values for the maximally permitted transmitting power are given predefined for these antenna pieces and therefore the maximally preset values for the transmitting power cannot be exceeded towards this direction and/or this solid angle.

### CROSS REFERENCE TO RELATED APPLICATIONS

The present application claims priority to European patent application No.: 02 001 533.5, filed Jan. 23, 2002, which is herein incorporated by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to the field of mobile radio antennas and more particularly to a device for transmitting and receiving electromagnetic radiation, such as radio transmissions, with a number of transmitting elements, such as mobile telephones and other communication devices, located within spatially diversified radiation of a basic transmitting power by design.

Related devices are disclosed in an article by H. Briel entitled “Adaptive Antennas” of Funkschau, booklet 22, 1998. The mobile radiotelephone antennas described in this article are constructed as antenna arrays, in which transmitting and receiving elements are separately wired in a matrix-like fashion. The separate wiring thereby allows, at the reception, the so-called uplink to determine the location of the mobile sender, i.e. it is determined in detail by the evaluation of the phase and amplitude position in the individual receiving elements of the arriving signal, from which direction the transmitting signal of the mobile sender (for example mobile telephone) has been received. Correspondingly, at transmission of signals to the mobile sender, i.e. at the so-called downlink, the transmission can be done directionally specific by either the fixed beam method with individual transmitting elements of the antenna array, with their comparably narrow beams, or by the steered beam method by forming a new radiation diagram and using several transmitting elements with the respective set phase and amplitude relation. A communication which is particularly low in radiation and inexpensive between the mobile radiotelephone antenna and the mobile sender/receiver, for example a mobile phone, personal digital assistant, etc. can be obtained this way.

A need however exists for an inexpensive adaptability feature for this type of operation of mobile radiotelephone antennas as according to specific radiating characteristics and changing circumstances resulting from local obstructions and restrictions and in contrast to such functionality heretofore present only in limited, expensive and complex antennas arrangements. It thereby can still be indispensable, that it is for example approached very closely to the permitted limiting value for the non-ionizing radiation, although the operator of the radiotelephone antenna is willing to clearly remain under these limiting values for reasons of public acceptance.

An advantage of the present invention is to provide for a device for the reception and transmission of electromagnetic waves which is particularly well suited to enable very complex radiation patterns within a transmission field while at the same time remain within permissible transmission strengths or limiting values

This and other advantages are provided by a device comprising an antenna and a driving logical circuit for the transmitting elements provided in such a way that an individually presettable directional and/or angular limitation of the basic transmitting power on maximally permitted transmitting powers in selectable directions, and in particular selectable solid angles, is provided.

Accordingly, the radiated transmitting power for determined directions and/or determined solid angles deviates downwards from the normal basic transmitting power into the remaining directions and/or solid angles. The antenna is thereby easily calculable because determined directions and/or solid angles are assigned to certain pieces of the antenna and for these pieces of the antenna the preset values for the maximally permitted transmitting power are thereby given predefined and therefore maximally preset values for the transmitting power in this direction and/or solid angle cannot be exceeded.

A transmitting variant particularly low in radiation can be obtained from a conversion of an adaptive transmission and reception characteristic by the driver circuit. This way, the radiating beam can be used particularly efficiently for communication with a transmitter/receiver in motion. At the same time, the associated radiating beam with the transmitter/receiver in motion can reduce predetermined maximally permitted transmitting power—as set out above—if the transmitter/receiver moves into an area where the transmission should not be made with an otherwise regular transmitting power but only with a comparably lower transmitting power.

In a relatively simple way in terms of construction and circuit, this directional and in particular angular reduced radiation can be realized if a directional and/or angular limiting function is implemented in the driver circuit with which the value for the basic transmitting power in the corresponding direction can be replaced or superimposed in the corresponding direction and in particular the corresponding solid angle.

In a way which can be simply realized, this limiting function can be put into practice in the form of a stored programmable characteristic diagram, in which discretion for the direction and in particular for the solid angle and maximum values for the permitted transmitting power can be stored. The characteristic diagram can thereby for example be constructed in such a way that a complete angle of radiation of 360° divided in 10° steps comprise the respective values for the maximally permitted transmitting power. Alternatively, a characteristic diagram constructed according to spherical coordinates can be provided, at which the azimuth angle θ and the angle φ can as well be of discretionary 10° steps and for each angle pair (θ, φ) a respective value for the maximally permitted transmitting power is stored. Alternatively, it is also possible that the limiting function is realized as well as a stored programmable characteristic diagram, in which diminishing discreet values for a direction and in particular for a solid angle, i.e. a number(s) which is greater than or equal to zero and smaller than or equal to one, is stored, with which the value for the basic transmitting power has to be multiplied. A further possible alternative comprises a reducing function which can be constructed as a continuous differentiable function or polynomial and as a function of the direction and/or as a function of the solid angle supplies respective values for the (if required) provided reduction of the transmitting power.

In this regard, it is further possible to provide an array structure of individual transmitting and receiving elements, whereby a permitted maximum value for the transmitting power, and in particular a diminishing value for the reduction of the basic transmitting power, is assigned to each transmitting and receiving element. This array structure, with which adaptive antenna systems can already be realized via a single antenna mast, is therefore predestined for this way of procedure with “protected” transmitting zones. It is thereby requisite for the observance of the maximally permitted transmitting power for a protected zone according to the definitions, that the permitted maximal value and in particular the diminishing value is also reduced according to the number of transmitting and receiving elements which are to be directed to the immediately neighboring and to the same party. Otherwise, excessive values for the transmitting power would result from the balanced radiated waves based on the superposition in the (desired) overlapping areas of the radiating beams.

Additional advantages are provided by an apparatus for remote electronic communication within a field of transmission, comprising: an antenna for sending and receiving transmissions within said field, and a driver logic circuit for controlling operation of said antenna, said circuit operatively connected to said antenna and facilitating said antenna to transmit at selectively adjustable transmission power levels according to select solid angles of transmission direction within said field.

### BRIEF DESCRIPTION OF THE SEVERAL VIEWS OF THE DRAWINGS

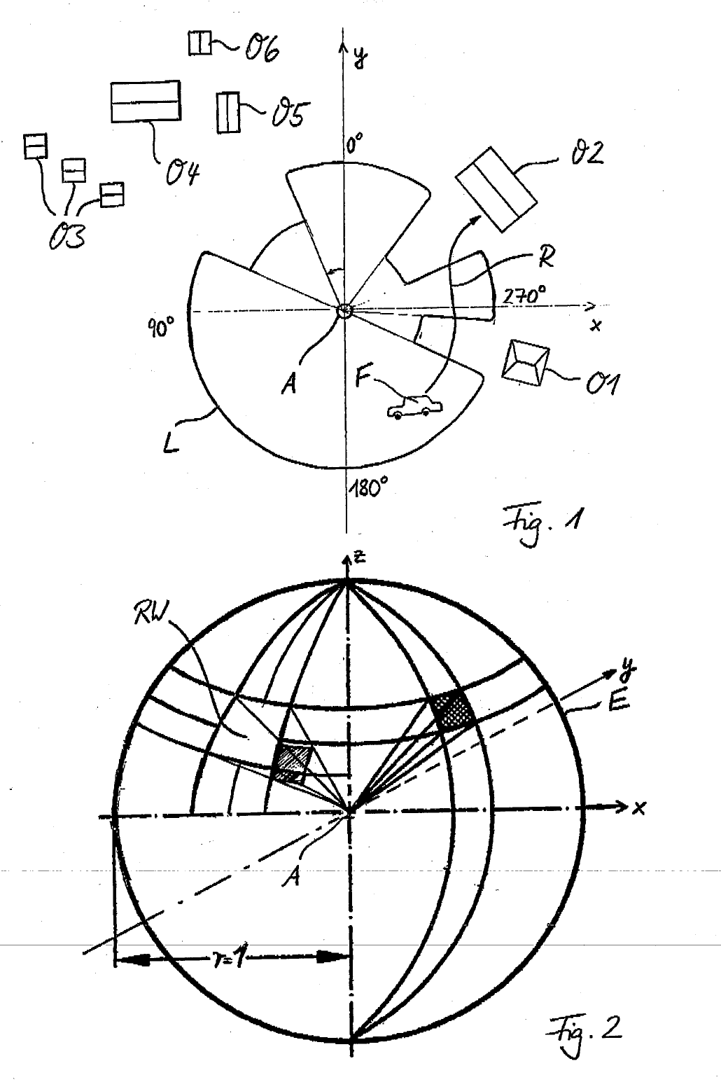

The novel features and method steps believed characteristic of the invention are set out in the claims below. The invention itself, however, as well as other features and advantages thereof, are best understood by reference to the detailed description, which follows, when read in conjunction with the accompanying drawing, wherein: FIG. 1 depicts a schematic disclosure of an aspect on the 0 dB line of a mobile radiotelephone antenna with a number of protected areas; and FIG. 2 depicts a disclosure with a three-dimensional function for the reduction of the mobile radiotelephone transmitting power at a mobile radiotelephone antenna constructed as an array.

### DETAILED DESCRIPTION OF THE INVENTION

FIG. 1 depicts a schematic disclosure of an aspect on the 0 dB line L of an example circular radiating mobile radiotelephone antenna A. The mobile radiotelephone antenna A transmits within frequency range of 925 to 960 MHz with a maximum system limiting value for the electrical field strength of 4 V/m. The basic transmitting power is thereby accordingly defined.

Based on the presence of a series of objects numbered 01 to 06 and depicted in FIG. 1, a series of areas also exist where it is not allowed to radiate with the basic transmitting power. For example, objects 01 and 02 correspond to homes or buildings wherein persons regularly stay for extended periods of time. Accordingly, the transmitting power has to be substantially reduced so as to guarantee the best possible protection for these persons. Accordingly, in the direction of 01 and 02, an electrical field is transmitted with a strength particularly tailored to reach a maximum of 0,4 V/m at locations 01 and 02. In another depicted area including objects 03 to 06, the electric field is radiated at a slightly higher level, namely electrical field strength of 0,6 V/m, because this area, while certainly in need of protection from maximum field strength, is a bit further removed from the mobile radiotelephone antenna A than objects 01 and 02. The electrical field strength is thereby reversed proportional to the single distance of the mobile radiotelephone antenna A (far field). Below is a table of possible multipliers of maximum field strength based upon angle of transmission.

TABLE
Direction in degree of angle for the basic transmitting power
in the corresponding directions.

| Range (Degree) | 0-30 | 31-68 | 69-242 | 243-265 | 266-292 | 293-320 | 321-359 |
|---|---|---|---|---|---|---|---|
| Multiplier | 1.0 | 0.15 | 1.0 | 0.10 | 1.0 | 0.1 | 1.0 |

Table: Direction in degree of angle for the basic transmitting power in the corresponding directions.

The above table shows, in which way the basic transmitting power is diminished in the areas which need to be particularly protected. This table can thereby be stored in a driver unit for the mobile radiotelephone antenna A in the form of a characteristic diagram.

By way of example, the function of the characteristic diagram will now be discussed for a mobile radiotelephone subscriber moving along a route R with a vehicle F having a mobile telephone along the route R. In the output area the maximum permitted transmitting power equals the basic transmitting power. Corresponding to the quality of the radio circuit and the measured level at the up and downlinks, a level lying clearly below the basic transmitting power is automatically set based on the proximity to the mobile radiotelephone antenna.

The mobile radiotelephone antenna A, which is designed in the present embodiment as an array-like constructed base station, allows the follow-up of the radiating beam along the direction of motion of the mobile radiotelephone subscriber on his route R. However, upon entering a protected zone, herein around object 01, a clearly diminished value applies for the maximum transmitting power permitted in this area as is based upon the diminishing factor stored in the characteristic diagram. The capacity of the mobile radiotelephone emissions to the mobile radiotelephone subscriber in this zone is thereby reduced. As a follow upon this reduced transmitting power, despite transmitting with the maximal transmitting power permitted in this area it can happen that an area within the mobile radiotelephone antenna A and located leeward from object 01 is possibly insufficiently supplied with a surface density or signal. The antenna diversity can here take remedial measures, where a second in phase transmitting antenna is provided, the measure sufficiently or supplementary covering this leeward area from another location within its emission area.

Upon leaving this protected area, by the mobile radiotelephone subscriber along his route, the range in this area now rises again accordingly to the maximum permitted transmitting power. The mobile radiotelephone subscriber is expected to not be effected by this in the present case because the radio circuit concerning him can make do with a substantially lower transmitting power based upon its short distance from the mobile radiotelephone antenna A. Nevertheless, at least one of the eight slots is used for the transmission of the control channel upon which the mobile radiotelephone is based as is the case with TDMA (time division multiplex access) system methods. Notwithstanding, a non-operative base station or one at rest transmits the control channel permanently and with full power on all eight channels per cell even without existing communication with parties. The advanced data services compared to the GSM-standard, like HSCSD, GPRS and EDGE, share this characteristic.

With reference to FIG. 2, another embodiment is depicted comprising an array-like constructed mobile radiotelephone antenna A. The limitation of the maximally permitted transmitting power is provided in the present case as well. A three-dimensional characteristic diagram is however given for the diminishing factors, which is constructed according to spherical coordinates. Space segments are obtained from the present context described as solid angles, which, if necessary, may be impinged with a reduced maximally permitted transmitting power compared to the basic transmitting power. Accordingly, FIG. 2 depicts a standard sphere E with a radius 1 and only a solid angle RW for reasons of clarity, in which transmissions may be made at only approximately 50% of the basic transmitting power. A radiating beam moving into this solid angle area, experiences therefore the intended reduction of the maximally permitted transmitting power.

Because of the narrow spatial overlaps of the radiating beams, which are radiated from the transmitting elements of the antenna array adjacently arranged, a further diminishing factor can additionally be provided besides the above described diminishing values, which value correlates with the number of the immediately adjacent transmitting elements to be sent to a subscriber. With the moving of the radiating beam from one transmitting element to the next immediately adjacent transmitting element, the transmitting power in the so far leading transmitting element can for example be reduced in favor of the transmitting power in the following or trailing transmitting element in that the sum of the radiated power of these two transmitting elements is not greater than the maximally permitted transmitting power radiated from a transmitting element. This additional reduction of the transmitting power at such adjacently radiating transmitting elements does not only apply to the particularly protected areas of transmission, but also for all remaining areas of transmission which may be irradiated with the basic transmitting power.

It is therefore possible, by mathematical means in the driver logic, to particularly compose the desired radiating beam by a separate approach of the single transmitting elements and to thereby remain under the respective values for the maximally permitted transmitting power, which are stored in the characteristic diagram or as an analytic function of the direction or of the solid angle.

Accordingly, particular adaptively working base stations whose drive approaches the individual antenna elements in such a way that pre-defined areas which have to be particularly protected are actually operated only with the permitted transmitting power according to the present invention may be realized.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. An apparatus for remote electronic communication within a field of transmission, comprising:
an antenna for sending and receiving transmissions within said field, and
a driver logic circuit for controlling operation of said antenna, said circuit operatively connected to said antenna and facilitating said antenna to transmit at selectively adjustable transmission power levels according to select solid angles of transmission direction within said field.

2. The apparatus according to claim 1, wherein said selectively adjustable transmission power is adaptive to changing circumstances within said field of transmission.

3. The apparatus according to claim 1, wherein said transmission power levels are based upon a basic transmission power multiplied by a select factor and assigned to a spatial area within said field, said spatial area being defined by said select solid angles.

4. The apparatus according to claim 3, wherein said select factor represents a maximum value for permitted transmission power levels within said select spatial area, and said value is stored within a memory.

5. The apparatus according to claim 4, wherein said value is stored as a programmable characteristic diagram.

6. The apparatus according to claim 5, wherein said value is a real number.

7. The apparatus according to claim 1, wherein said antenna further comprises an array-structure of individual transmitting and receiving elements, each having assigned thereto a maximum permissible transmission power.

8. The apparatus according to claim 7, wherein said maximum permissible transmission power is adjusted according to a maximum permissible transmission power of an adjacent element.

9. The apparatus according to claim 1, further comprising means for cooperating with another antenna, said another antenna providing a transmission signal to an area located leeward from a mobile communication unit located within said field.

10. The apparatus according to claim 1, wherein said electromagnetic waves are radio waves.

11. The apparatus according to claim 1, wherein said spherical angles cooperate to form a circle.

12. The apparatus according to claim 1, wherein said spherical angles cooperate to form a sphere.
